(19) United States
(12) Patent Application Publication
(10) Pub. No.: US 2023/0419857 A1
(43) Pub. Date: Dec. 28, 2023

(54) QUARTERBACK DECISION MAKING AND LEARNING POTENTIAL ANALYSES AND PREDICTIONS

(71) Applicant: Cadence123 LLC, Ft Lauderdale, FL (US)

(72) Inventors: George Godsey, Baltimore, MD (US); Lisa Calkins, Boulder, CO (US); Heath O'Neal, Thornton, CO (US); David Harold Frakes, Rancho Santa Fe, CA (US)

(21) Appl. No.: 18/340,536

(22) Filed: Jun. 23, 2023

Related U.S. Application Data
(60) Provisional application No. 63/354,981, filed on Jun. 23, 2022.

(51) Int. Cl. G09B 19/00; A63B 24/00

(52) U.S. Cl. CPC G09B 19/0038; A63B 24/0075; A63B 2024/0081

(57) ABSTRACT

The present disclosure presents systems and methods for analyzing a user's cognitive abilities related to decision-making in fast-paced scenarios. One such method comprises inputting, by the computing device, the one or more matrix metrics into a predictive model of a learning potential for the user; executing, by the computing device, the predictive model of the learning potential of the user; predicting, by the computing device using the predictive model, the learning potential of the user; and outputting, by the computing device, the predicted learning potential of the user.

### CROSS-REFERENCE TO RELATED APPLICATION

This application claims priority to co-pending U.S. provisional application entitled, “Quarterback Decision Making and Learning Potential Analyses and Predictions,” having application No. 63/354,981, filed Jun. 23, 2022, which is entirely incorporated herein by reference.

### TECHNICAL FIELD

The present disclosure is generally related to systems and methods for assessing the decision making ability and learning potential of a user during computer simulation participations.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram illustrating an exemplary computing system or device that can be utilized for systems and methods of the present disclosure.

FIGS. 2-15 show example illustrations from a user's perspective for various modules of an exemplary teaching and evaluation application in accordance with various embodiments of the present disclosure.

### DETAILED DESCRIPTION

The present disclosure relates to systems and methods for analyzing a user's cognitive abilities (e.g., learning potential) related to decision-making in fast-paced scenarios, such as within an American football computer simulation.

This interactive solution is designed to measure, teach, and improve a team athlete's decision-making skills, whose role depends on his/her ability to make smart, fast decisions. Accordingly, an exemplary teaching and evaluation application is adapted for an American football quarterback position. Therefore, users can use this tool to improve their cognitive ability to quickly break down a situation into the key components that drive the best decision by a user in the quarterback role. By using the training tool repetitively, a user can improve his or her decision making skills, which will translate to improved field performance.

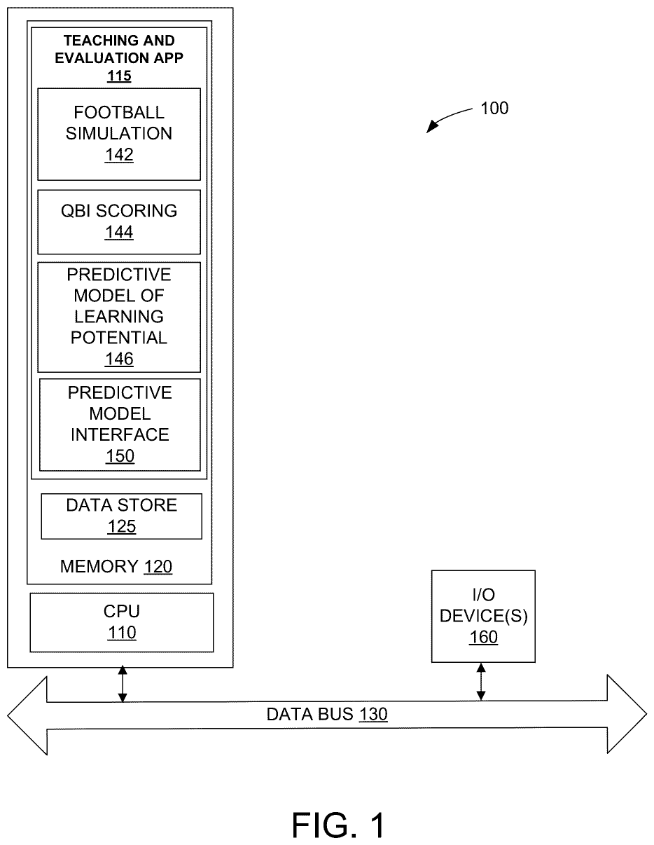

In one embodiment, an exemplary teaching and evaluation application 115 (FIG. 1) provides various modules to facilitate the learning of football plays to a user that can include Gameplay, Learning Center, Practice, and Insights modules. For example, through an interactive game, players are presented with various plays uniquely designed to measure and score decisions made by a user and corresponding decision times. In various embodiments, this tool provides combinations of formations, coverages, situations, and variables designed explicitly for this decision-making type. The ideal decision time and relative decision time scale are determined for each of these combinations. The plays are organized into sessions and situations designed to encourage learning. For example, sessions may be organized from an initial rudimentary starting point that evolves in complexity as the user progresses in learning the courses until their acumen is ready to begin the next session. After each session, players can view a session summary with the option to replay and learn. As a player advances their skills, they are given more challenging situations and new learning opportunities. The application is using previous gameplay data to determine the types of learning the player needs to advance. The Learning Center module includes a playbook that provides information and insights into the plays and coverages based on the level of the player. This is combined with analytics that includes summary scoring information to help the player understand their strengths and areas to improve.

Additionally, a unique formula has been created to determine the cognitive skill level of a player in this position. The inputs (e.g., matrix metrics) to this scoring formula include various data components collected through the Gameplay module including the level of play, demographic player information, decision, decision time, situation, situational importance, playtime, and scenario. For example, in evaluating the gameplay of a user, the user can be shown a simulation of a football play and be enabled to identify an action for the quarterback position, such as throwing to a first wide receiver, a second wide receiver, a running back, tight end, etc. that are eligible receivers for the play being executed. Accordingly, the user may have several options to choose from and based on which decision is made, the user will be evaluated, since certain option(s) are considered to be better than others based on the play being run, how the play unfolds, and how the opposing team is defending the play. As such, the variables that need to be considered by the user and used to identify the best option are dynamic.

In addition, an additional factor or variable that contributes to computing the outcome score (e.g., QBi) is a game context to which the play is being run, such as a first down in the first quarter with the game having a 0 to 0 score versus a fourth down in the last 20 seconds of the fourth quarter with the user's team down by 6 points. Accordingly, the decision making of a user when executing a certain football play may be considered to be more critical or importance in the context of the game and may be weighted more than other less critical plays. Correspondingly, the time it takes for a user to make a decision is another factor to be considered in computing an outcome score, since there is a limited amount of time that a quarterback generally has to make a decision before the play ends or before the opportunity closes to choose the correct option.

Thus, in various embodiments, the various variables or factors present a matrix of options that can be attributed to user where each selected option or measured parameter (e.g., a matrix metric, such as throwing to a covered receiver or taking 5 seconds before throwing the ball) can be evaluated and scored, since each has a different value that can contribute to a final score for the individual play. For the quarterback position, this will be their quarterback intellect (QBi) score. The QBi score, gameplay, learning, and comparison data may then be used to provide a predictive analysis of players' cognitive abilities (e.g., learning potential) related to decision-making in fast-paced scenarios. Such predictive analysis can be used by current coaches, future coaches, scouts, or other evaluators who desire an objective evaluation of a user's cognitive abilities or aptitude within a particular field, such as the field of playing the quarterback position. Since, in practice, quarterbacks play at different sized schools at different skill levels and using different offensive schemes, it is difficult to assess an individual's current quarterback decision making abilities in addition to their potential in learning and developing their quarterbacking skills. As such, the evaluations provided by the exemplary teaching and evaluation application can provide an objective basis for assessing and comparing the cognitive decision making skills of quarterback prospects.

FIG. 1 is a block diagram illustrating an exemplary computing system or device 100 that can be utilized for systems and methods of the present disclosure. Computing system 100 includes at least one processor, e.g., a central processing unit (CPU), 110 coupled to memory elements 120 through a data bus 130 or other suitable circuitry. Computing system 100 stores program code within memory elements 120. Processor 110 executes the program code accessed from memory elements 120 via the data bus 130. In one aspect, computing system 100 may be implemented as a computer or other data processing system, including tablets, smartphones, or server computers that are accessed using browsers (or other client application) at client computers. It should be appreciated, however, that computing system 100 can be implemented in the form of any system including a processor and memory that is capable of performing the functions described within this disclosure.

Memory elements 120 include one or more physical memory devices such as, for example, a local memory and one or more storage devices. Local memory refers to random access memory (RAM) or other non-persistent memory device(s) generally used during actual execution of the program code. Storage device may be implemented as a hard disk drive (HDD), solid state drive (SSD), or other persistent data storage device. Computing system 100 may also include one or more cache memories (not shown) that provide temporary storage of at least some program code in order to reduce the number of times program code must be retrieved from storage device during execution.

Stored in the memory 120 are both data and several components that are executable by the processor 110. In particular, stored in the memory 120 and executable by the processor 110 are code for simulating plays within an American football game (142) as part of the teaching and evaluation application 115, code for computing a QBi score based on a user's gameplay within the simulation (144), code for a predictive model of the learning potential of the user (146) and code for interfacing with the predictive model and outputting a predictive learning potential outcome from the predictive model (150). Also stored in the memory 120 may be a data store 125 and other data. The data store 125 can include an electronic repository or database relevant to predictive model results. In addition, an operating system may be stored in the memory 120 and executable by the processor 110. In an embodiment, predictive model data are stored in the data store 125, such as model parameters.

For example, a predictive model may include a digitally constructed model that refers to an electronic digitally stored set of executable instructions and data values, associated with one another, which are capable of receiving and responding to a programmatic or other digital call, invocation, or request for resolution based upon specified input values, to yield one or more stored output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

Input/output (I/O) devices 160 such as a keyboard, a display device, and a pointing device may optionally be coupled to computing system 100. The I/O devices may be coupled to computing system 100 either directly or through intervening I/O controllers. A network adapter may also be coupled to computing system to enable computing system to become coupled to other systems, computer systems, remote printers, and/or remote storage devices through intervening private or public networks. Modems, cable modems, Ethernet cards, and wireless transceivers are examples of different types of network adapter that may be used with computing system 100.

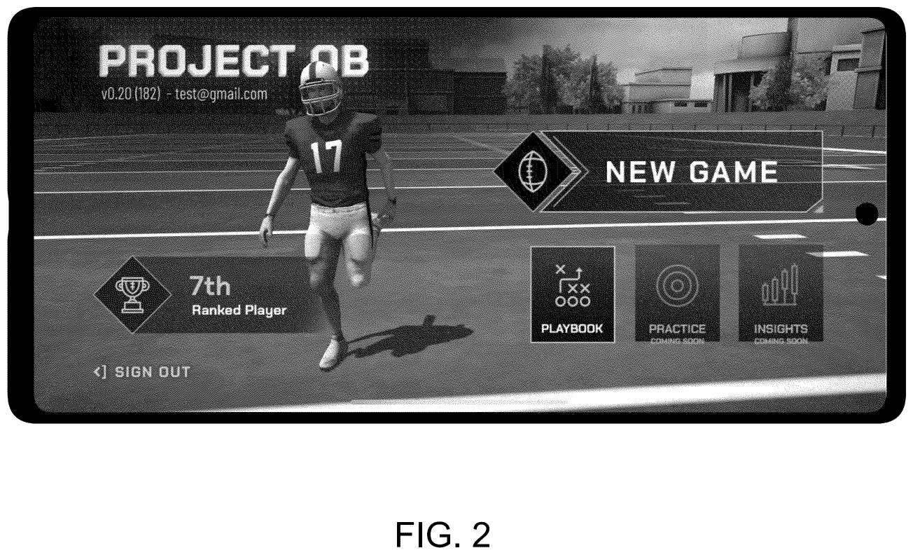

FIGS. 2-15 show example illustrations from a user's perspective for various modules of an exemplary teaching and evaluation application 115 (for a smartphone implementation). FIG. 2 illustrates a Home Screen that enables users to access key features of the computer application. These include interfaces to the Gameplay, Learning Center, Practice, and Insights modules. In one exemplary embodiment, a subscription-based model unlocks coaching sessions, player game customizations, sharing, and settings. For example, the Practice mode or module can be used in conjunction with the Learning Center module to practice concepts and situations. The Practice mode does not impact the player's gameplay rank and score. In various embodiments, there are various Practice options available, including situational specific, personalized based on gameplay, coach/team developed, and others. Additionally, the Insights mode or module highlights the player's strengths and improvement areas based on scenarios and situations that include average decision time, % based on ideal decision time, play results totals, and personalized feedback. As part of the Learning Center module, a series of professionally developed instructional sessions, tailored by level, along with Practice modes and session tests can also be provided, in certain embodiments.

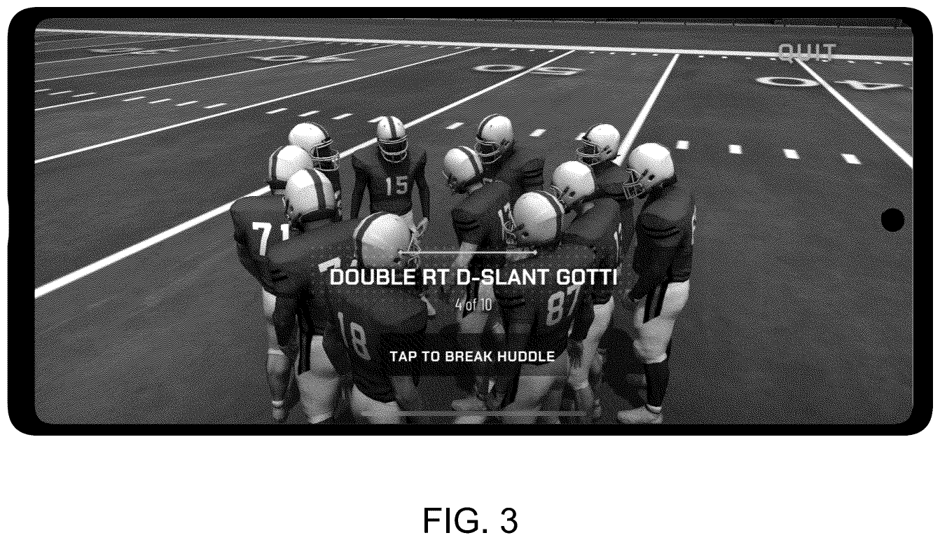

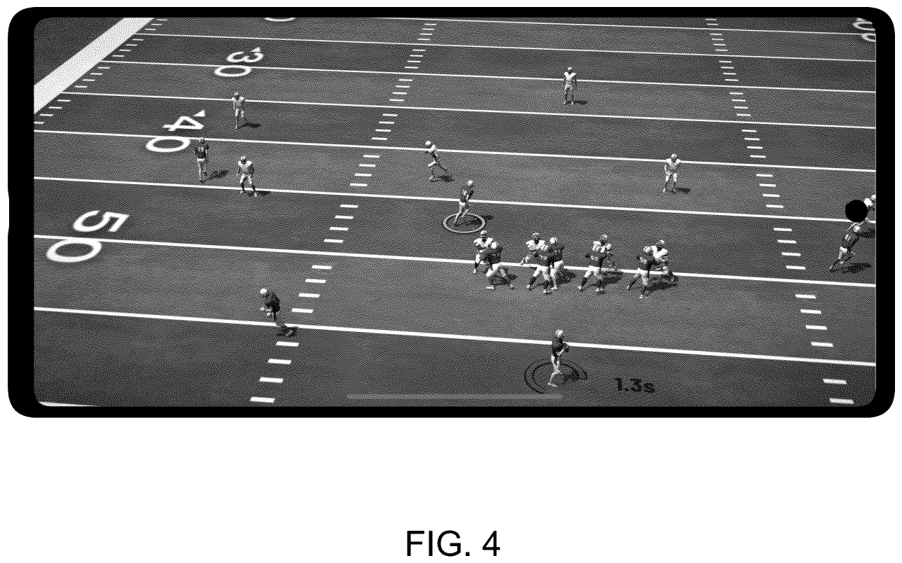

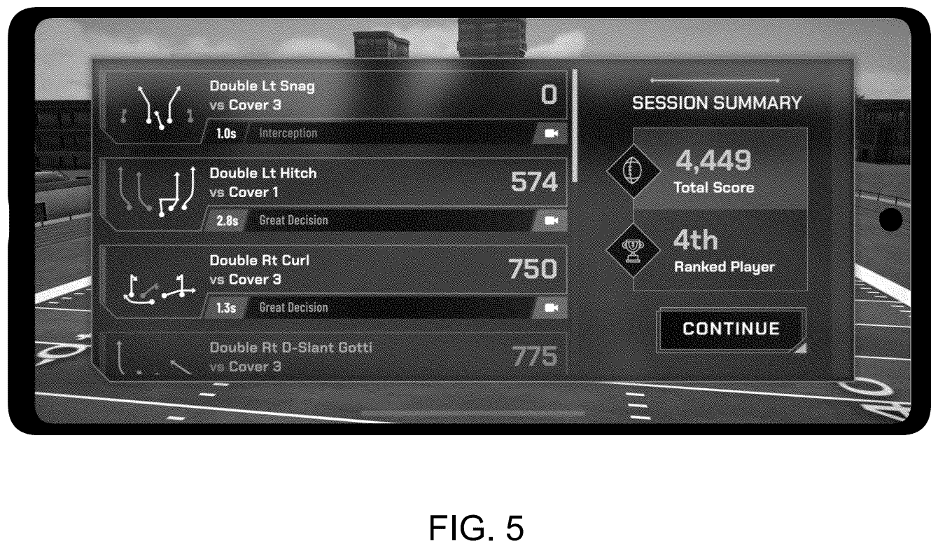

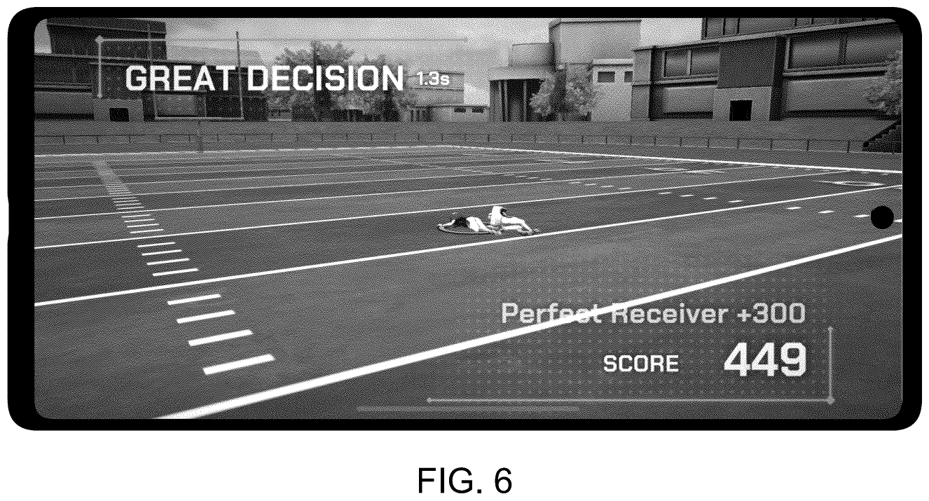

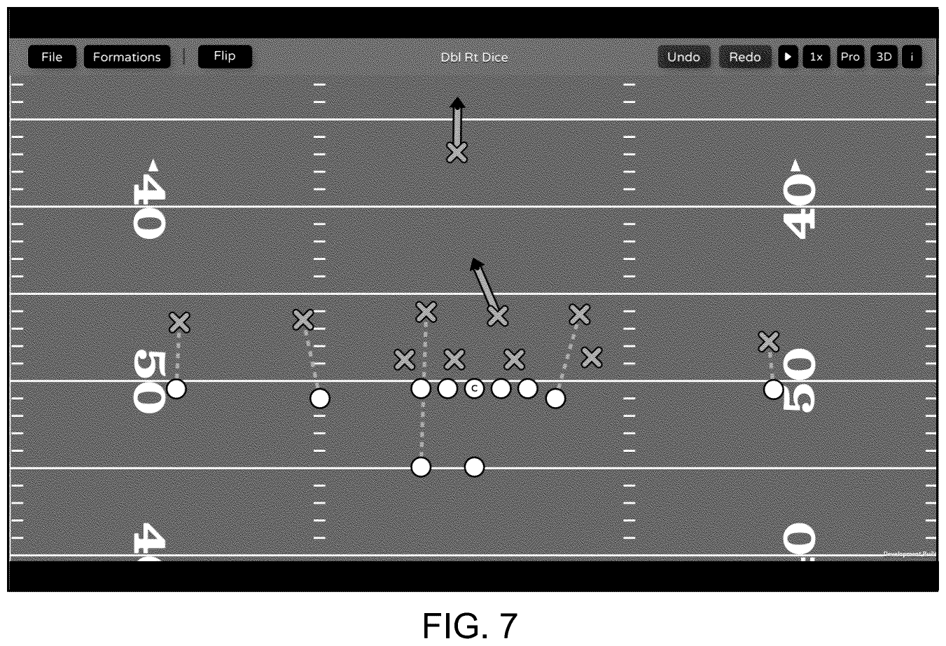

FIGS. 3-4 illustrate Gameplay screens. In general, the Gameplay module is organized into sessions to foster the decision-making process. There are various game modes based on levels, including random, personalized based on past performance, and others. Players see the play name and initiate the play clock start, as shown in FIG. 3. The decision time is a critical part of the gameplay. Because of this players have a designated amount of time specific to the play, as shown in FIG. 4. The decision, decision time, and other scoring opportunities, including bonuses for streaks, decision time, and other factors, and play results are displayed. The logic is driven by the complex rules of gameplay that are derived from and include algorithms for defensive players matching with offensive players. FIG. 5 illustrates a Session summary screen. The session summary displays the detailed play results, total session score, and player's level rank. The player can replay any completed plays to review their decision and see the results for the unselected options, as shown in FIG. 6. FIG. 7 illustrates a Playbook screen from the Learning Center module. Players can join and be validated to teams set up by the team administrator. They are then provided with plays in their playbook and sessions of plays that are specific to their team. Statistics on players' game performance are accessible by the coach/team administrators.

An exemplary application is designed for the user to create and edit the play content used in the game. Users can create a play from templates, previous plays, or from scratch. Each play has many customizable components, including receiver speed, run type, optimal receiver, optimal decision time, and others. After completing a play, the user can view how the play will be seen in the game in 3D and make any adjustments the user wants. A coach can use the setup wizard to configure plays for their team, school, etc. These are then only accessible to the users associated with that team.

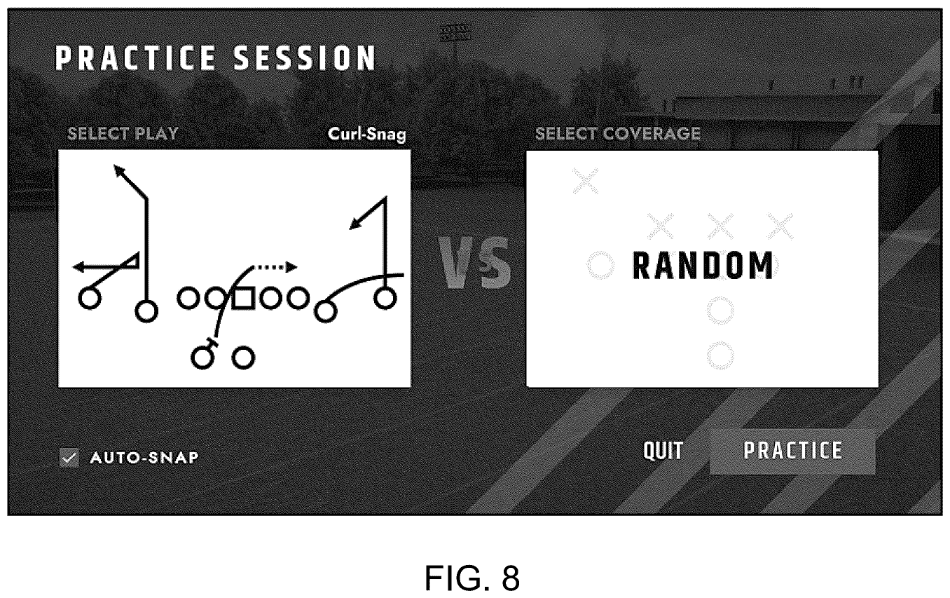

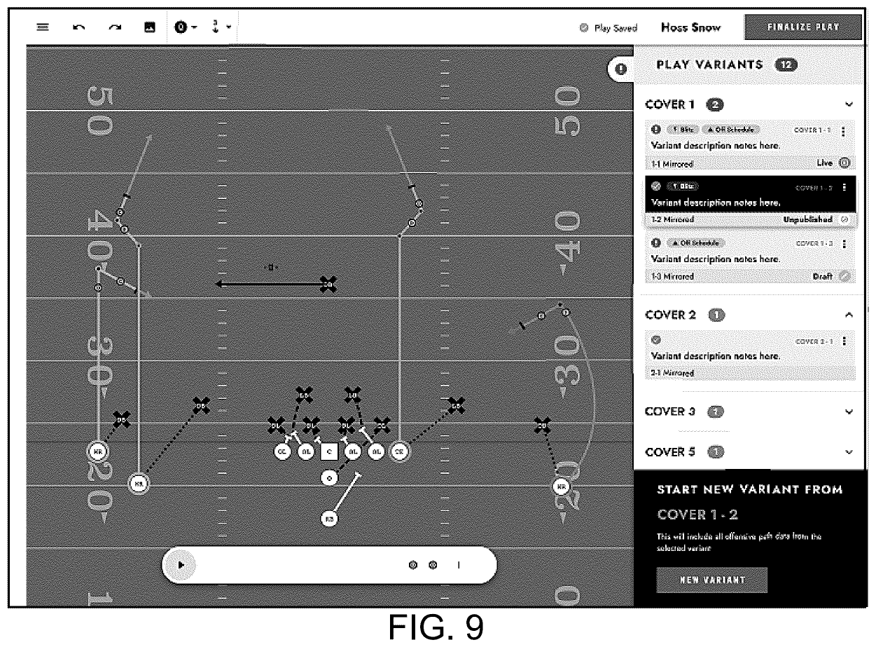

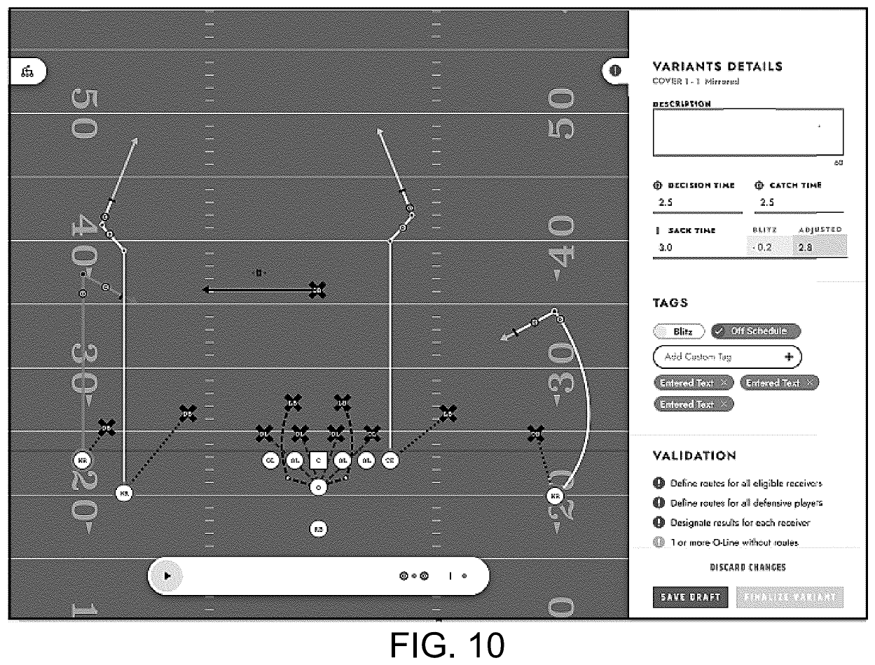

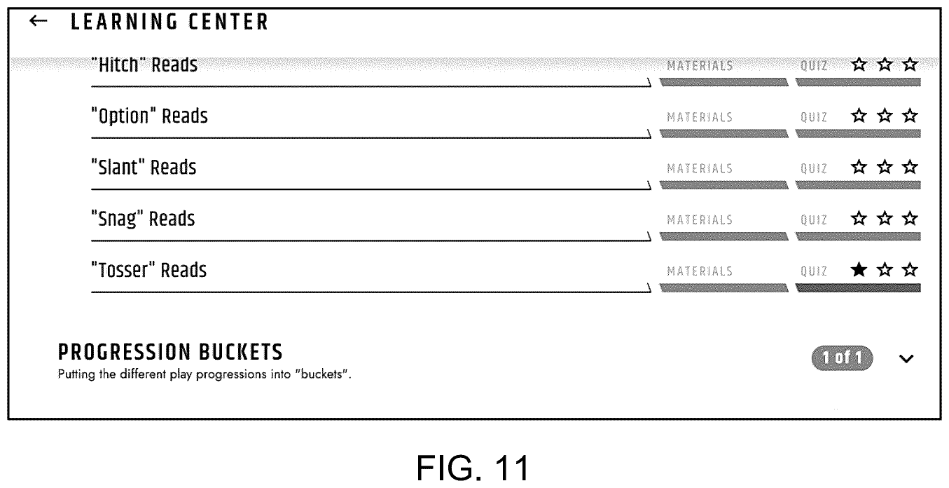

Thus, there are various Learning Center options for each level, including basic playbooks, team-specific playbooks, situational specific, and others. For example, FIG. 8 illustrates the option of specifying particular offensive plays for a quarterback user with the choice of specifying a particular defensive coverage to practice against or the choice of having a random defensive coverage selected for the user to practice against. As such, the Learning Center module will include valuable information on how to read complex patterns as they unfold quickly. In addition, it will explain the methodology to break down the steps to follow based on information as it presents itself to make the best decisions in the shortest amount of time. For a specified defensive coverage, variants may also specified within the coverage, such as Cover 1, Cover 2, Cover 3, or Cover 5 for a secondary or defensive backfield unit, as illustrated in FIG. 9 (showing a user interface screen of an offensive play design against a selected defensive coverage variant) and for the selected variant, the designated amount of times specific to the play are provided, such as decision time, catch time, sack time, as illustrated in FIG. 10 (showing an offensive play design against a selected defensive coverage variant). The visual and textual information is augmented with audio instructions. Practice and Gameplay tests are included to demonstrate a player's learning, as illustrated in FIG. 11 (which shows a screenshot of quarterbacking reads that a user can be taught and tested or quizzed as part of the Learning Center mode). The data feeds into the personalized, generated sessions in the Game and Practice mode and is used in the analysis and predictive models of a player's cognitive performance and learning potential.

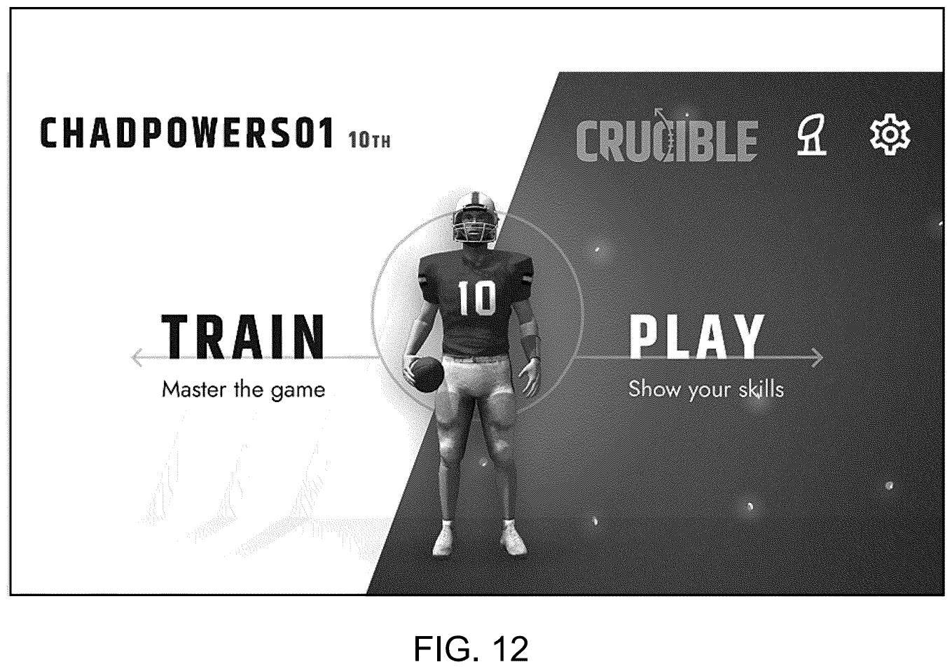

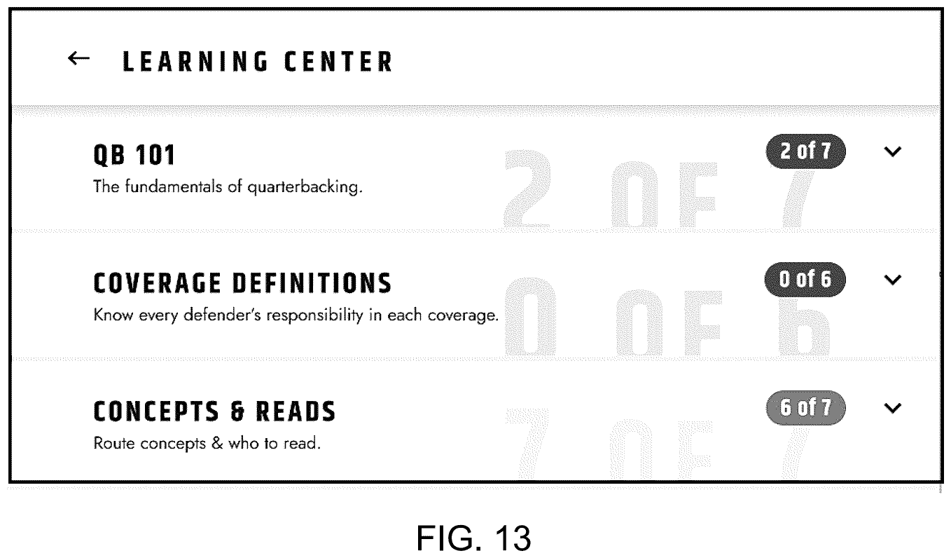

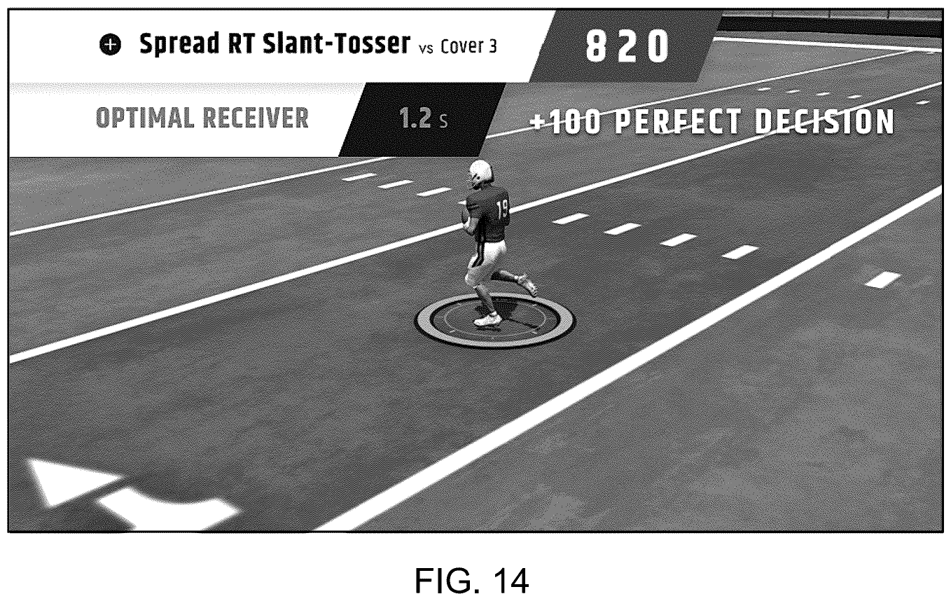

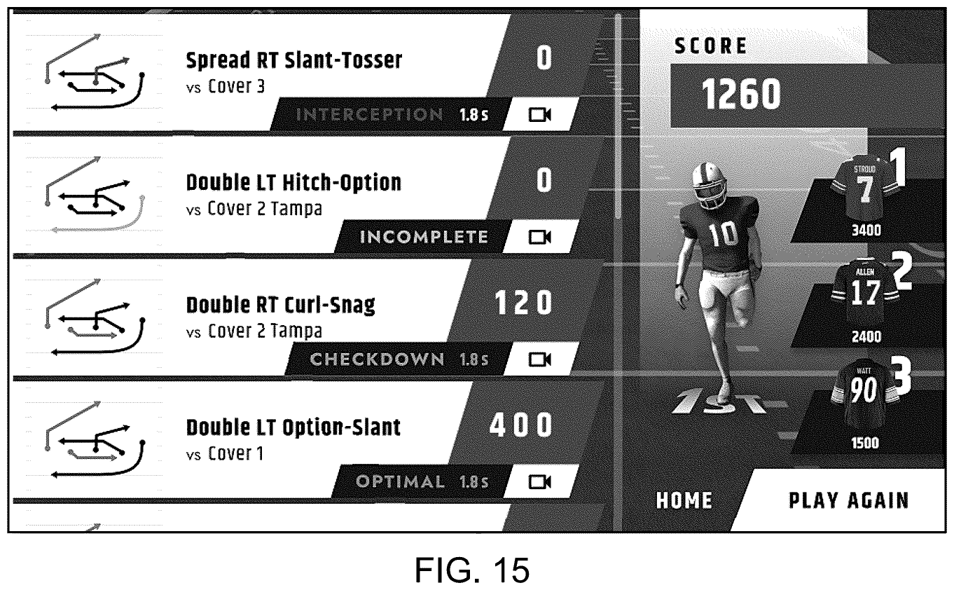

As discussed, the Practice mode or module can be used in conjunction with the Learning Center module to practice concepts and situations. For example, FIG. 12 illustrates a interface screen that allows a user to choose to train/practice or to play a game. Accordingly, if the user selects the training or practice option, the user can be provided practice sessions on various fundamentals for their respective position (e.g., quarterback) for which they can participate, as illustrated in FIG. 13 (which shows a Learning Center screenshot of the training sessions that have been completed by the user). Correspondingly, if the user selects the play option (from FIG. 12), the user can play a game, as illustrated in FIG. 14 (which shows a screenshot of gameplay) and be scored based on their gameplay, as illustrated in FIG. 15 (which shows the user's overall QBI score and individual scores attributed to particular plays).

Computer program code for carrying out operations of the present disclosure may be written in a variety of computer programming languages. The program code may be executed entirely on at least one computing device (or processor), as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer.

It will be understood that each block of the flowchart illustrations and block diagrams and combinations of those blocks can be implemented by computer program instructions and/or means. These computer program instructions may be provided to a processor of a general purpose computer, special purpose computer, application specific integrated circuit (ASIC), or other programmable data processing apparatus to produce a machine, such that the instructions, which execute via the processor of the computer or other programmable data processing apparatus, create means for implementing the functions specified in the flowcharts or block diagrams.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

1. A method comprising:
obtaining, by a computing device, one or more matrix metrics based on a user's participation in an American football computer simulation;
inputting, by the computing device, the one or more matrix metrics into a predictive model of a learning potential for the user;
executing, by the computing device, the predictive model of the learning potential of the user;
predicting, by the computing device using the predictive model, the learning potential of the user; and
outputting, by the computing device, the predicted learning potential of the user.

2. The method of claim 1, wherein the one or more matrix metrics comprise a quarterback intellect score acquired during the user's participation in the American football computer simulation.

3. The method of claim 1, further comprising displaying a graphical user interface on the computing device, wherein the graphical user interface displays the American football computer simulation.

4. The method of claim 1, wherein the predictive model is configured to determine a type of learning that is best-suited for the user.

5. The method of claim 1, further comprising assessing, by the computing device, decision making of the user in executing a play based on actions available to be selected by the user during the play.

6. The method of claim 1, further comprising assessing, by the computing device, decision making of the user based on a game context to which a play is being executed by the user.

7. The method of claim 6, wherein the game context includes the play being executed on 4th down in a 4th quarter with the user's team being behind in points to an opposing team.

8. A system comprising:
a processor of a computing device;
a memory in communication with the processor, the memory storing program instructions, the processor operative with the program instructions to perform the operations of:
obtaining, by a computing device, one or more matrix metrics based on a user's participation in an American football computer simulation;
inputting, by the computing device, the one or more matrix metrics into a predictive model of a learning potential for the user;
executing, by the computing device, the predictive model of the learning potential of the user;
predicting, by the computing device using the predictive model, the learning potential of the user; and
outputting, by the computing device, the predicted learning potential of the user.

9. The system of claim 8, wherein the one or more matrix metrics comprises a quarterback intellect score acquired during the user's participation in the American football computer simulation.

10. The system of claim 8, wherein the operations further comprise displaying a graphical user interface on the computing device, wherein the graphical user interface displays the American football computer simulation.

11. The system of claim 8, wherein the predictive model is configured to determine a type of learning that is best-suited for the user.

12. The system of claim 8, wherein the operations further comprises assessing decision making of the user based on a game context to which a play is being executed by the user.

13. The system of claim 12, wherein the game context includes the play being executed on 4th down in a 4th quarter with the user's team being behind in points to an opposing team.

14. A non-transitory computer-readable storage medium embodying programmed instructions which, when executed by a processor, are operable for performing operations comprising:
obtaining one or more matrix metrics based on a user's participation in an American football computer simulation;
inputting the one or more matrix metrics into a predictive model of a learning potential for the user;
executing the predictive model of the learning potential of the user;
predicting, using the predictive model, the learning potential of the user; and
outputting the predicted learning potential of the user.

15. The non-transitory computer-readable storage medium of claim 14, wherein the one or more matrix metrics comprises a quarterback intellect score acquired during the user's participation in the American football computer simulation.

16. The non-transitory computer-readable storage medium of claim 14, wherein the operations further comprise displaying a graphical user interface, wherein the graphical user interface displays the American football computer simulation.

17. The non-transitory computer-readable storage medium of claim 14, wherein the predictive model is configured to determine a type of learning that is best-suited for the user.

18. The non-transitory computer-readable storage medium of claim 14, wherein the operations further comprise assessing decision making of the user based on a game context to which a play is being executed by the user.

19. The non-transitory computer-readable storage medium of claim 18, wherein the game context includes the play being executed on 4th down in a 4th quarter with the user's team being behind in points to an opposing team.

20. The non-transitory computer-readable storage medium of claim 14, wherein the operations further comprises assessing decision making of the user in executing a play based on actions available to be selected by the user during the play.
